(19) United States
(12) Patent Application Publication
(10) Pub. No.: US 2018/0339926 A1
(43) Pub. Date: Nov. 29, 2018

(54) METHOD AND APPARATUS FOR PROCESSING MFT USING ULTRA-THIN-LAYER DRYING

(71) Applicant: Dry Tailings Incorporated, Douglas (CA)

(72) Inventor: Colin D. McLeod, Douglas (CA)

(73) Assignee: Dry Tailings Incorporated, Douglas (CA)

(21) Appl. No.: 15/938,675

(22) Filed: Mar. 28, 2018

(30) Foreign Application Priority Data
May 23, 2017 (CA) 2968078

(51) Int. Cl. C02F 11/16

(52) U.S. Cl. CPC C02F 11/16; C02F 2103/10

(57) ABSTRACT

There is described a method and apparatus for dewatering or drying mature fine tailings (MFT) associated with oil sands mining operations using ultra-thin-layers, and more particularly a method and apparatus for continuously spreading ultra-thin-layers of MFT over a silica sand substrate and simultaneously harvesting the dried MFT, while at the same time pumping a supply of MFT from a central canal.

### PRIORITY

This application claims priority to Canadian Patent Application No. 2,968,078, filed May 23, 2017, which is hereby incorporated by reference for all purposes as if set forth herein in its entirety.

### TECHNICAL FIELD

This disclosure relates to the treatment of mature fine tailings, or fluid fine tailings, herein abbreviated as “MFT” or “FFT”, to facilitate the transport, disposal and deposition of the tailings. In particular, this disclosure relates to the dewatering or drying of MFT using ultra-thin-layers, and more particularly to a method and apparatus for continuously spreading ultra-thin-layers of MFT over a silica sand substrate and simultaneously harvesting the dried MFT, while at the same time pumping a supply of MFT from a central canal.

### BACKGROUND OF THE INVENTION

Tailings are a by-product of all mining operations. The tailings could originate from any number of processes, including, but not limited to, various mining operations, and the term tailings could also encompass various sludge and other liquid/solid materials that need to be dewatered and transported.

For example, during the extraction of oil from oil sands ore, the raw material extracted from the earth generally comprises about 85% sand and clay, 10% oil or bitumen, and 5% water. This material is generally processed by mixing the ore with hot water, with the bitumen froth rising to the top and floated off. After removal of the bitumen, the bitumen depleted slurry generally contains various mixtures of natural materials including water, fine clays and silts, left-over bitumen, salts and soluble organic compounds, including solvents added during the separation process. These are generally considered oil sands tailings.

Oil sand tailings are discharged and contained in large earthen structures above ground—known as tailings ponds—or in former mine pits awaiting reclamation. Currently there are hundreds of square kilometers of tailings ponds located in the oil sands region of Western Canada.

It is desired to dispose of the oil sands tailings so as to minimize impact on the environment. It is further desired and sometimes even required by local legislation to restore the mined land to a semblance of its original condition.

The larger sand particles in the tailings settle very quickly to form a stable deposit, while the finer clay particles and left over bitumen take years to settle out and are known as mature fine tailings (MFT) or fluid fine tailings (FFT).

The MFT may be treated to remove some of the left-over bitumen. However, this treated MFT still presents a significant environmental problem since it does not provide a surface that is sufficiently solid so as to support trees and other vegetation necessary to return the mined land back to its original state.

What is needed is a way to restore the processed tailings back to the original mine site in a condition that will permit the site to be returned to its original state. To do so, the processed tailings must be strong enough—dry enough—to support the original overburden without causing sinking or creating depressions that were not present in the original landscape. The goal is to use the original material as much as possible to avoid carting in landfill from other areas.

In one known method, a cyclone separator is used to separate out coarse sand particles from a raw tailings stream. Coarse sand particles exiting from the separator may be used to build tailing pond berms. A slurry stream of fine tailings is delivered from separator to a gravity sedimentation device known as a thickener. The thickener produces a thickened slurry that is mixed with gypsum, sands and flocculent in a blending device or mixer and then conveyed to a settling and drying pond. The pond is dredged to capture the settled MFT, which is blended with additional flocculent and deposited on drying beds with enhanced drainage. The deposited layer may be churned or “farmed” by bulldozers to accelerate evaporation. The dried materials may then be transported back to the excavation site and covered with a previously sidelined overburden in an attempt to return the land to its original condition.

Disadvantages of this method are that the high concentrations of water in the slurries require a substantial amount of time for drying and consolidation to transform the MFT to a trafficable state. The time to dry tailings is generally no less than 30 days. Moreover, the drying process entails significant costs in managing the drying beds, and the end result is usually not trafficable or conveyable without the use of additional filters, centrifuges or sand in excess of the quantities available on site

WO 2014/1005570 describes a method for stabilizing the fine-particle slurry of oil sands tailings by absorbing a certain amount of free water thus making the resulting slurry resistant to flow, conveyable and more porous to accelerate the drying process. The method comprises combining coarse particles with a slurry of fine particles to generate a composite slurry having a substantially predetermined ratio of coarse particles to fine particles and subsequently mixing superabsorbent polymer (SAP) with the composite slurry in an amount effective to produce a somewhat friable, flow resistant semi-solid yet conveyable composition.

In a conference paper presented at the 2010 British Columbia Mine Reclamation Symposium at the University of British Columbia, Canada, titled “OIL SANDS TAILINGS TECHNOLOGY: UNDERSTANDING THE IMPACT TO RECLAMATION, author Melinda Mamer, described the new Tailings Reduction Operations (TRO) being developed by Suncor Energy Inc., as a process of mixing MFT with a polymer flocculent, then depositing it in thin layers and allowing it to dry. In this process, MFT is dredged out of the tailing ponds, a polymer flocculent is added, and the mixture is deposited in thin layers with shallow slopes. In the described process, the deposited layers were generally 10-15 cm thick. Over a matter of weeks, the material dries resulting in a product that can be reclaimed in place or moved for final reclamation. The disadvantage of this method is that the long drying times limit the volume of recovered material and/or require large drying areas to accommodate the massive amount of MFT that must be treated.

What is needed is a method and apparatus for dewatering the MFT that will produce treated tailings that are sufficiently dry so as to be able to support the original overburden in a short enough time span such that the process can be carried out in a relatively small land area, as a continuous operation.

### SUMMARY OF THE DISCLOSURE

The method and apparatus for processing MFT using ultra-thin-layer drying as disclosed herein addresses some of the shortcomings of the prior art and provides a new way to quickly and economically treat MFT so that it can be effectively used to restore the mined land to a semblance of its original condition before the mining

Accordingly, then, in one aspect, there is provided, a method for dewatering mature fine tailings (MFT), the method comprising: depositing a thin layer of MFT onto a surface of a substrate; leaving the thin layer of MFT on the surface for a pre-determined amount of time to permit evaporation of water from the MFT into the atmosphere and drainage of the water into the substrate, thereby creating dried MFT having a desired solids content; and harvesting the dried MFT off the surface, wherein the thin layer of MFT is less than 100 mm in thickness.

In another aspect, there is provided a mobile MFT distribution and pickup device for dewatering mature fine tailings (MFT) on a surface of a drying area, the device comprising: a control and power supply module; a drive means configured to move the device over the surface of the drying area in at least a forward direction; at least one pipe lateral and tool support structure connected to the control module, the pipe lateral and tool support structure comprising: a lateral MFT distribution pipe; at least one MFT layering tool connected to the lateral MFT distribution pipe configured to deposit a thin layer of MFT onto the surface of the drying area as the device moves over the surface; and at least one MFT pickup tool configured to harvest dried MFT off the surface as the device moves over the surface; and a pump configured to pump the MFT into the distribution pipe.

### BRIEF DESCRIPTION OF THE DRAWINGS

Referring to the drawings wherein like reference numerals indicate similar parts throughout the several views, several aspects of the method and apparatus for processing MFT using ultra-thin-layer drying are illustrated by way of example, and not by way of limitation, in detail in the figures, wherein:

FIGS. 1a and 1b show the natural water distribution in the Earth's surface;

FIG. 2 shows one test conducted by the applicant for drying MFT on a silica sand substrate;

FIG. 3 shows another test conducted by the applicant for drying MFT on a silica sand substrate;

FIG. 4 shows yet another test conducted by the applicant for drying MFT on a silica sand substrate;

FIGS. 5a to 5d show the transformation of the thin layer of MFT illustrated in FIG. 4 into a dried chard of MFT;

FIG. 6 shows a simplified representation of an area that can be used for drying MFT using the method and apparatus described herein;

FIG. 7 shows a more detailed representation of a suitable area that can be used for drying MFT using the method and apparatus described herein;

FIG. 8a shows one example of a pipe lateral and tool support structure, being one component of the lateral MFT distribution and pickup device disclosed herein;

FIG. 8b is a cross-sectional view along the lines A-A in FIG. 8a;

FIG. 9 shows multiple pipe lateral and tool support structures connected in series to provide extended coverage over a large MFT drying area;

FIG. 10 shows one example of an MFT layering tool;

FIG. 11 shows one example of an MFT pickup tool; and

FIG. 12 shows a control and power supply module which connects to the first pipe lateral and tool support structure for controlling and supplying power to all of the pipe lateral and tool support structures and to pump MFT from the supply canal.

### DETAILED DESCRIPTION OF THE DISCLOSURE

Applicant's testing shows that MFT from oil sands tailings ponds has an affinity for a silica substrate composed of glass particles sized by passing through a 212-micron sieve.

When the silica substrate is dry, there is resistance to MFT flowing as a surface layer over the substrate but gradually the attractive capillary forces in the substrate overcomes initial resistance and water drains from the surface MFT into the substrate. Analysis of oil-bearing sand deposits indicates that the sand has a high silica content (about 95.5%) similar to that of the above-noted glass beads used in the applicant's testing. Therefore, when crushed and sieved to the same approximate size distribution as oil-bearing sand, the crushed glass beads served as an effective way to simulate the behaviour of sand in oil-bearing sand deposits.

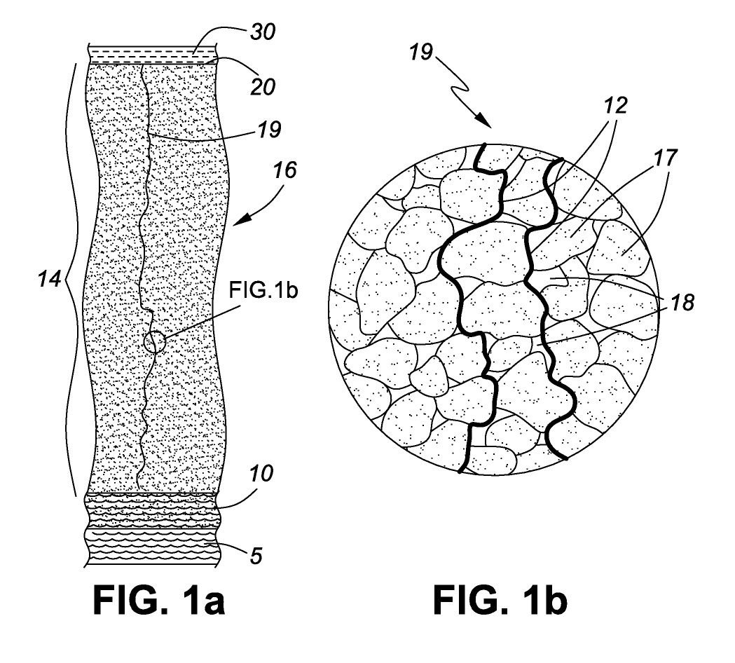

FIGS. 1a and 1b, illustrate the natural water distribution in the Earth's surface for a sandy substrate 16. Generally, at the lower levels, the substrate 16 is water-saturated, with water filling all the available voids. The upper portion of this level is known as the water table 5 (see FIG. 1a). Directly above the water table 5 there is an active zone 10 consisting of capillary water 12 and varying amounts of non-capillary water. The final and upper-most zone, capillary zone 14, extends from active zone 10 to the surface 20, and is comprised of capillary water 12, sand grains 17, and voids 18. Capillary zone 14 may have temporary non-capillary water flowing through from surface water surcharges. The capillary water 12 forms a capillary chain 19, which is a continuous chain or column of water reaching from the surface 20 to the active zone 10. An upward capillary force (also referred to as capillary action) holds the capillary chain 19 in place within the substrate against the force of gravity. If water is removed from the upper portion of the capillary chain 19 by drying or by roots of plants having a greater capillary/osmotic attraction, then this water is replaced by water flowing up through the capillary chain 19 from the water table 5 and/or the active zone 10 below. The capillary force always acts to pull water from more water-saturated areas of the substrate to less water-saturated areas.

The sandy substrate surrounding a tailings settling pond located within a confinement dyke is a uniform substrate that is subjected to the same capillary forces as described above, with the water table 5, which within a confinement dyke is a perched water table, established by the surface of the tailings pond and the sand beach surface serving as the upper limit of the capillary zone 14. Because of the uniformity of the sandy substrate composition, the capillary forces should be equal at equal heights above the perched water table across the entire area. Therefore, a land levelled sand surface should provide a uniform capillary surface force across the levelled area.

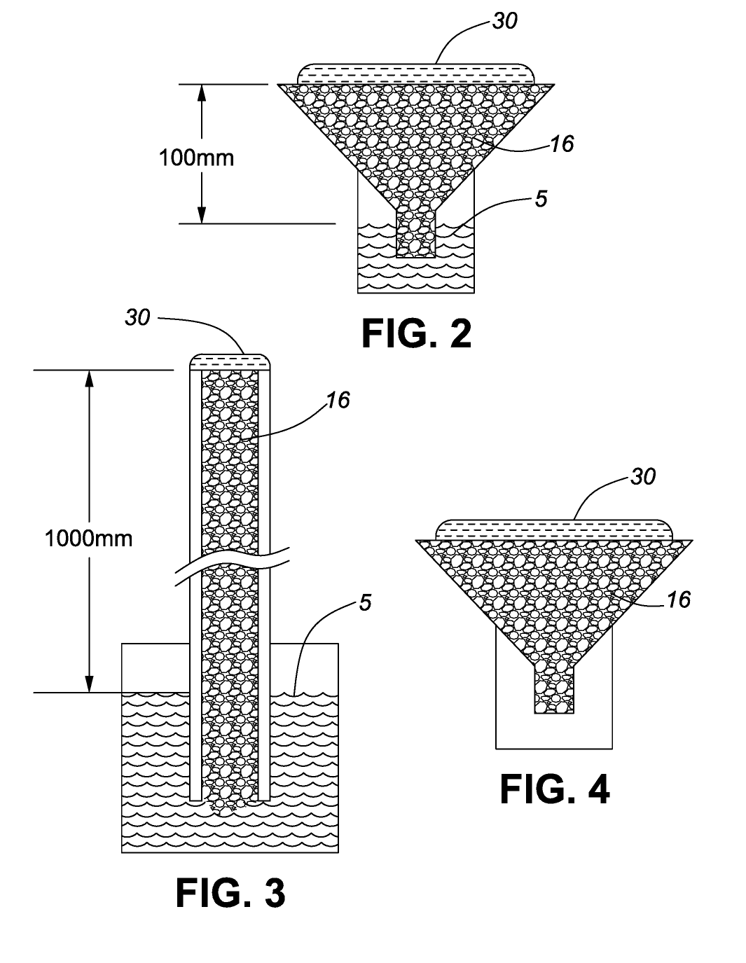

As shown in FIG. 2, applicant's bench tests show that a water-saturated silica substrate 16, having 81% solids, located only 100 mm above an artificial water table 5 will drain water from an overlaying layer of MFT 30 and increase the solid content of the MFT from 32% to 66% solids. Drainage continues until a moisture equilibrium is reached between the water table 5, the silica substrate 16, and the MFT layer 30. In this example, the silica substrate 16 remained water-saturated at the surface after the MFT layer 30 was removed as long as the water table 5 remained in contact with the silica substrate 16, drying out only after access to the underlying water table pool was removed. This example suggests that water will drain from the MFT layer 30 into the water table 5 through a water-saturated silica substrate 16 having 81% solids—a point where the silica substrate void spaces 18 are volume-saturated with water—until the MFT solid content reaches 66%. It is important to note that once the MFT layer 30 has dried to 66% solid, 75% of the water originally in the MFT has drained into the water table 5. If this process was to take place on the sand beaches of the tailings settling pond, the drained water would flow back into the tailings settling pond and become available for re-use by the bitumen mining and upgrading processes. As a result, only 25% of the original MFT water content would be lost from the tailings pond when this system of capillary and gravity dehydration is used. 16% of the moisture is lost to evaporation, with the remaining 9% remaining locked in the dried MFT which is collected and transported off-site. Thus, using this method of combined evaporation and capillary drying, the total MFT drying capacity can be amplified beyond the basic environmental evaporation potential in locations near the settling ponds where capillary and gravitational forces can remove the bulk of the water.

Applicant's tests have determined that when MFT dries from 32% to 85% solids, each millimeter-thick layer of water removed dries a 1.19 mm-thick layer of MFT. Also for each millimeter of water evaporated an additional 4.7 mm of water can be removed into the substrate by the capillary and gravitational activity. As a result, in the time it takes for 1 mm of natural evaporation, a 6.7 mm layer of MFT can be dried to 85% solids.

In the oil sands area, there is approximately 600 mm of annual evaporation. This is called “shallow lake evaporation”. During the drying season from mid-April to the end of August, there are approximately 143 days and 450 mm of evaporation potential. Unfortunately, this is also the wet season and on average 230 mm of rain can be expected. In general, this would imply a net evaporation potential of 220 mm. If amplified by using capillary and gravitational effects as described above, an MFT layer of 1,474 mm could be dried. By using special rapid deployment and removal equipment to deposit and remove MFT, it would be possible to avoid exposing drying MFT to rainfall events and thereby prevent re-wetting. As a result, even more of the 450 mm evaporation potential could be utilized.

Bench test drying of a layer of MFT 30 was also conducted using a vertically-oriented tube containing a silica substrate 16. The top of a tube was located one meter above an artificial water table 5, as shown in FIG. 3. The silica substrate 16 in the tube was completely covered and sealed with the MFT cap layer 30 that dried to 77% solids, before reaching a moisture equilibrium with the water table 5. At first, the MFT layer 30 drained quickly as the capillary forces in the substrate 16 pulled water out of the MFT layer 30, eventually reaching moisture equilibrium with the water table 5 below. After moisture equilibrium was reached between the MFT 30 and water table 5, water flow reversed, with water flowing up through the substrate 16 into the MFT cap 30 replacing water that was evaporating from the MFT 30. The top surface of the MFT layer 30 exposed to the air remained uniformly wet even when exposed to bright summer sunshine for an entire day.

During the test, the capillary chain connection between the MFT cap 30 and the silica substrate 16 was severed with a sharp blade leaving the cap loosely in place. This broke the capillary chain and the MFT layer 30 dried quickly well beyond 80% solids, the point at which the MFT layer began to twist and curl, and transform from a dark plastic solid to a light-coloured brittle solid. This suggests that after a capillary chain link is established through the silica substrate 16 between the MFT layer 30 and the water table 5, a moisture equilibrium is reached between the substrate and the MFT. If additional moisture is removed from the MFT cap 30 then the water flow is reversed, with water from the capillary chain, and eventually the water table 5, flowing upwards, replacing water evaporated from the MFT. To maximize the potential for capillary forces to dehydrate a surface layer of MFT, the capillary chain must be broken after a state of moisture equilibrium is reached between the MFT surface layer and the water table, and before the water flow reverses. Breaking this connection prevents water in the water table from replacing water being evaporated from the MFT layer and only the minimal moisture that remains in the MFT at this equilibrium stage needs to be evaporated.

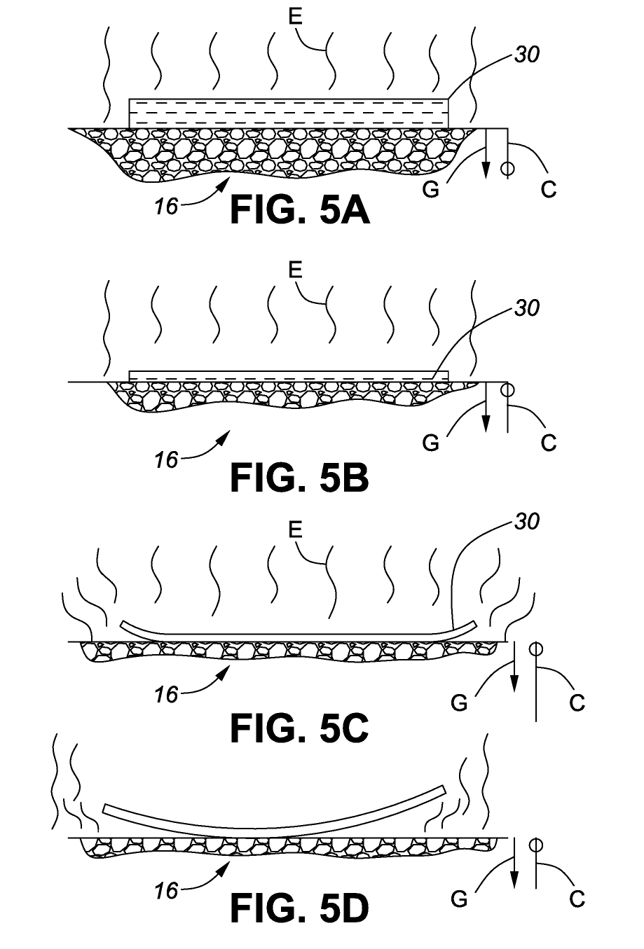

Applicant conducted further bench tests with a single MFT layer 30 placed on a silica substrate 16 held in a large funnel as shown in FIG. 4, and further illustrated in FIGS. 5a-d. The shape of the funnel provided a large surface for the MFT layer 30 and a reasonable depth that provided a suitable volume to accumulate water for drainage tests. When a 4.2 mm thick layer of MFT 30 was applied to the surface of the silica sand substrate 16, the MFT covered the surface to within 6 mm of the edge of the funnel. The funnel was placed in a round jar in the open air and subjected to open air drying in the summer sun. There was no connection to a source of ground water. In several tests, the humidity was high with variable sunny skies. Samples were left to dry for six hours. The MFT solid content increased from 32% to 85%. Applicant notes that according to the Technical Guide for Fluid Fine Tailings Management, published by the Oil Sands Tailing Consortium (OSTC) and Canada's Oil Sands Innovation Alliance (COSIA), Aug. 30, 2012, MFT must attain a solids content of 75% to 80% (by weight) to develop sufficient long-term stiffness and strength.

As shown in FIG. 5a, in the initial stage of drainage, both the gravitational force G and the net capillary force C pull water down and out of the MFT layer 30 into substrate 16, while evaporation E takes water up into the atmosphere. At this stage, the net capillary force C assists gravity G by wicking water out of the moisture-laden MFT into the drier substrate layers below. As the moisture is drawn out of the MFT layer 30 into the substrate 16 an upward capillary force develops in the drying MFT layer 30. Eventually, as shown in FIG. 5b, once a moisture equilibrium is reached between the MFT 30 and the substrate 16, the net capillary force C is directed upward and there is a balance reached between the downward gravitational force G and the upward net capillary force C. FIGS. 5c and 5d show that as the drying MFT 30 approaches 80% solids, it begins drying rapidly around the perimeter edges and the colour changes from dark grey to light grey. At this point, the exposed MFT layer 30 has dried sufficiently to break the capillary chain, which reduces the flow of water into the MFT layer 30 from the silica substrate 16 below. The outer, top edge of the MFT layer 30 dries faster than the rest of the MFT, causing the edges to curl up and inward. This severs even more capillary connections between the MFT cap 30 and the substrate 16 below, and the drying process accelerates until the MFT layer 30 is fully disconnected from the underlying silica substrate 16 and all replacement water flow into the MFT layer 30 stops. Eventually, as the edges of the MFT layer 30 dry and curl upwards, the MFT layer 30 separates completely from the silica substrate 16 and becomes a dried shard 34, ready to be collected and removed. The MFT chard 34 is a dry, non-sticky material that can be handled cleanly with simple machinery.

Applicant's testing showed that when MFT is spread beyond its free-flowing perimeter edge depth on a rigid surface, it does not retract from the surface, even as the MFT dries. The MFT will remain attached to the rigid surface holding the perimeter fixed. However, when MFT is spread in the same manner over a partially dried silica substrate, rollback of the MFT layer will occur, since some of the silica particles coat the MFT, forming a stronger bond with the MFT than with the other silica particles below. The plane where the silica particles are either bound loosely to each other or strongly to the overlaying MFT layer, forms the failure plane between the MFT layer and high silica substrate below.

The applicant has found that the minimum thickness of the MFT layer 30 that can be placed on silica sand substrate 16 before rollback occurs, is a function of the surface relationship between the solid and the liquid. The relationship is defined by the surface tension of the MFT slurry, the density of the MFT, and the cohesion and capillary forces that interact between the MFT slurry and the silica sand particles. The applicant's testing has found that the strong surface tension of the MFT slurry and its density appear to be the most important factors in determining the minimum thickness of the MFT layer. If surface pressure is applied to a MFT layer 30 overlaying a substrate 16 of high silica content particles, the MFT layer 30 will spread out into a layer having a thickness that is less than what would result with surface tension alone. As soon as the pressure is removed, the surface tension causes the perimeter edges of the MFT to roll back, thickening the MFT layer until the hydraulic pressure created by the MFT slurry layer exactly balances the surface tension at the edges. The applicant's testing has found that for a layer of MFT on a silica substrate the minimum hydraulic neutral depth or thickness is between 3.7 mm and 4.7 mm, with an average depth or thickness of 4.2 mm when applied on a large scale for drying. In contrast, Applicant notes that the current state of the art in the oil sand industry considers a thin “lift” or layer of MFT to be about 100 mm.

Drying in ultra-thin layers as described herein by the applicant has a huge advantage, since the drying rate is a function of the inverse of the square of the layer thickness. With all other factors being equal, applying MFT in the thinnest possible layer will determine the maximum rate at which the MFT can be dried.

What is needed then is a quick and efficient means for depositing and collecting ultra-thin layers of MFT on a silica substrate. The system needs to be simple, automatic, and inexpensive to install and operate.

In principal, applying a thin layer of MFT can be accomplished by pumping the MFT at a fixed rate though an extruder that moves at a fixed rate over the surface to produce a controlled, uniform, ultra-thin layer. Water from the MFT will drain into the substrate and dry through evaporation, and the layer will become much thinner than the original layer thickness. In some places, the MFT will crack and curl up as the moisture drains to reach an equilibrium with the underlying water table. If the MFT is deposited in a layer that is too thick, the equilibrium moisture level reached by the MFT layer will likely be higher than desirable. While the resulting MFT will be a plastic semi-solid, it will most likely have a high enough moisture content to retain a stickiness that will adhere to mechanical surfaces and generally interfere with gathering and disposal. A plastic, sticky layer of MFT, partially bonded to a silica sand substrate, is a formidable material to isolate and remove. An additional problem occurs when rapidly covering large areas of silica sand with a thick layer of MFT. The layer of MFT traps air that filled the voids in the silica substrate that were created after the previous surge of moisture drained into the underlying water table. The presence of trapped air, particularly in larger voids, forces the water around rather than through these air-filled voids slowing the drainage process.

Mechanically severing contact between the MFT and substrate layers (using a blade, wire, pneumatic pressure etc.) is possible, however, the most practical method is to deposit the MFT in a non-continuous, ultra-thin layer that takes advantage of the unique thin-layer MFT drying behaviour described above by the applicant. This behaviour provides three advantages for drying and gathering the MFT. First, as the non-continuous, ultra-thin layer of MFT dries the capillary connection between the silica substrate and the MFT layer is severed. This allows for more rapid evaporation, removing more water and stickiness from the MFT layer. Second, drying from the perimeter edges inward curls the edges upward, transforming the whole non-continuous layer into a collection of three dimensional shards laying on the surface. While the thickness of the dried MFT shards is about 1.5 mm, the curled edges give the shard pieces an additional effective thickness of up to 15 mm. This makes it possible for a mechanical device to easily collect the dried MFT from the surface. Third, air is able to escape from the silica substrate around the edges of the non-continuous layer segments as water drains from the layer into the substrate and so prevents air locks from forming.

The applicant's unexpected discovery that drying a non-continuous, ultra-thin layer of MFT, deposited with an appropriate ratio of surface area to perimeter edges, affects the shape and moisture content of the MFT, and allows for the practical design of equipment to economically spread, dry and collect ultra-thin layers of MFT. The ratio of surface area to perimeter edges will depend on the characteristics of the specific site, including its size and distance from the water table below. However, the basic relationship between the surface area of the MFT layer and its perimeter edge will determine its dried shape and moisture content. Drying ultra-thin layers of MFT in the manner described herein transforms the MFT from a sticky two-dimensional layer into a dried three-dimensional shard.

Applying MFT in an ultra-thin layer creates a small moisture differential between the upper and lower surface of the MFT layer, which is important as the moisture in the layer evaporates and drains to an equilibrium with the underlying water table. The strength of the bonds between particles at the upper and lower surfaces of the MFT layer are similar so that when the upper surface loses water to evaporation the lower surface has also lost enough moisture to approach the solid phase at nearly the same time as the top surface. The lower surface becomes semi-solid and bends upward as the top surface begins to shrink relative to the bottom surface due to evaporation. This contrasts with thicker MFT layers, which hold more interior moisture as the upper and lower surfaces dry. In thick layers, as the drying upper surface shrinks it merely slides against the underlying interior fluid and the entire MFT layer remains flat rather than bending upward in an arc as described above for ultra-thin layers.

As described above, an ultra-thin, non-continuous layer of MFT has a drying advantage that is only exploitable if suitable equipment is available to economically apply and collect large amounts of MFT in the manner described. The agriculture industry has been applying and collecting relatively thin applications of materials over large areas for decades. In fact, water is a primary agriculture input that is applied regularly in thin layers using huge mobile overhead irrigation structures. While large center-pivot machines are common, there are canal-fed lateral distribution irrigation systems where the water distribution structure extends perpendicular from a supply canal and moves parallel to the canal. The feed pipe inlet for the water pump dips into the canal and the inlet moves through the canal water as the mobile lateral structure moves along parallel to the canal. Thus, the water feed comes from a moving inlet as opposed to the more common fixed pivot inlet used with the rotating system. The canal-fed system is much simpler and more uniform from a distribution perspective since every section of the distributing lateral structure sweeps the same surface area at the same time. Whereas for rotating systems, nozzle diameters and spacing are needed to create variable flow rates to compensate for a rotating lateral arm that has sweep areas increasing along the lateral radius. The flexibility that nozzles offer in this situation is feasible only because water is an easy fluid to pump. In all of these agricultural irrigation systems high water velocities allow for relatively small delivery pipes that only require light mobile support structures.

To develop a mobile irrigation system able to distribute MFT in a non-continuous, ultra-thin layer, several modifications of the above-described water distribution system are needed. MFT has a viscosity 7-8 times greater than that of water, and it contains fine solids that are quite hard and abrasive. MFT also contains left-over, entrained bitumen globules that when flowing in a turbulent boundary layer can build up bitumen deposits on solid surfaces that can interfere with MFT flow. The existing mobile water irrigation systems generally include inline drive wheel pairs running parallel to one another. Each wheel pair is connected to the other by an overhead central water delivery pipe. The delivery pipe is attached to the drive wheel pairs at either end, and is supported by a series of cables and rigid structural members. The whole structure forms a stable triangular truss through which water flows and from which nozzles are connected that distribute water evenly between the wheel pairs. Multiple trusses may be connected to each other at wheel pair points to provide large, inline lateral distribution segment, able to irrigate large surface areas. The inline wheel pairs are transversely mounted to the pipe structures and drive them in a coordinated manner to keep the entire distribution lateral in a nominal straight line.

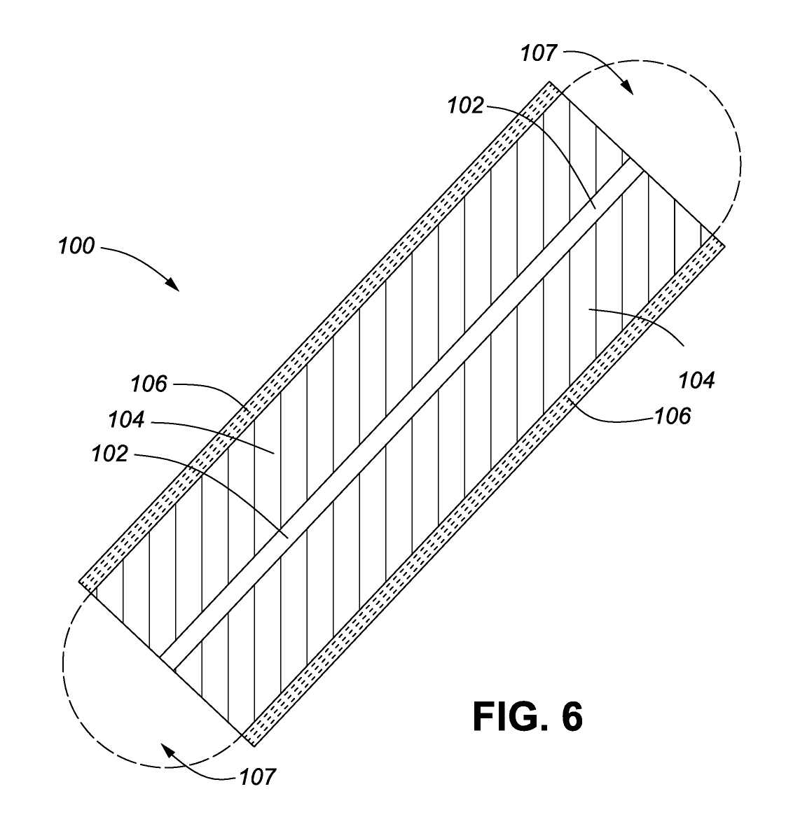

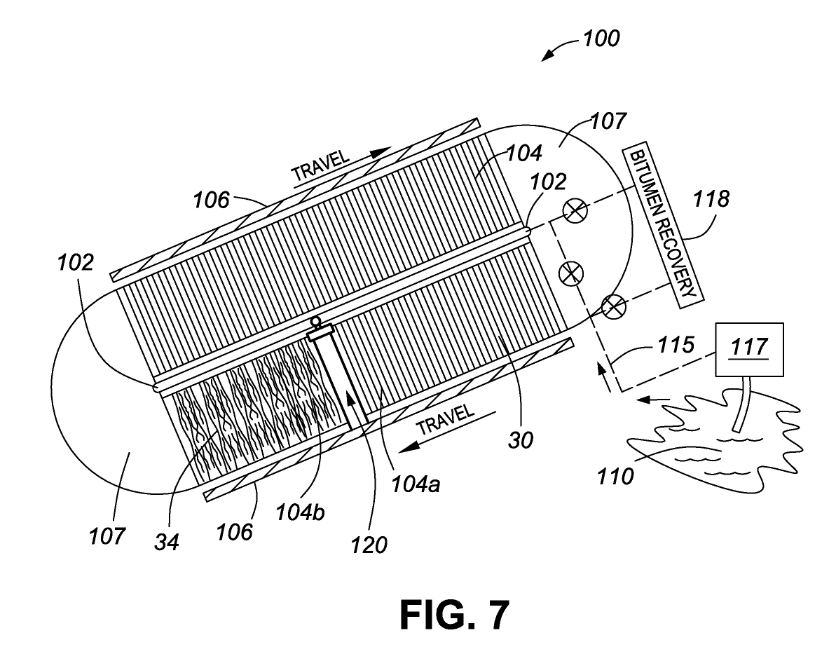

Like the water irrigation system describe above, the MFT processing system disclosed herein must perform its layering function over the same area repeatedly throughout the drying season. Unlike the irrigation system, however, the MFT processing system must also dry and harvest the MFT in a continuous process. FIG. 6 shows a simplified representation of an MFT drying area 100, including a central MFT distribution canal 102, which may be lined with plastic film, and two drying zones 104, one on either side of the canal. A windrow collection area 106 may be located at the outer edge of each drying zone 104 where the dried MFT can be deposited and temporarily stored. A lateral swing area 107 is located at each end of the canal 102 and drying zones 104 to permit the MFT distribution and collection equipment to turn. Drying area 100 should preferably be flat and level for its entire length and width to facilitate the easy pickup of the dried shards of MFT, which will generally have a depth of less than 15 mm. A typical approximate size for drying zones 104 is a width of about 100 meters and a length of about 1200 meters, providing an active drying area of 240,000 m² or 24 hectares. Of course, the size of drying zone 100 can vary depending on the scale of the MFT distribution and collection equipment and the amount of available land.

In a natural, open air drying system, where all drying energy is provided by the natural environment, large surface areas are required to dry large volumes of MFT. This can only be accomplished on a commercial scale using equipment that can deploy and recover MFT economically over a large surface area. The equipment must also have the ability to rapidly deploy and recover the MFT to avoid rainfall events. This system must exploit the natural climatic, and the capillary and hydraulic advantages gained from depositing ultra-thin layers of MFT on silica sand surfaces located near tailings settling pond containment areas in the oil sand mining region. Operating the MFT drying process continuously on the same prepared drying area 100 minimizes the capital investment needed. The drying area 100 must be designed to reflect a balance between process rate, surface area infrastructure, and equipment size and speed.

FIG. 7 shows a more detailed representation of a suitable MFT drying area 100 located on a leveled sand surface near a tailing settling pond 110, which will provide a continuous supply of MFT through a supply line 115, via pumping station 117, to the central MFT distribution canal 102. Supply line 115 may be fully or partially buried. Canal 102 may be lined with plastic film to prevent water from the MFT leaching into the surrounding sand, which would adversely affect the sand's drying abilities and would prematurely concentrate the MFT, thereby interfering with the thin-layer distribution process.

MFT is pumped at a low velocity through supply line 115, which reduces turbulence and subsequent bitumen deposits, and also reduces the friction flow losses that might be incurred by pumping high viscosity MFT. Reducing bitumen deposits and friction losses are both important considerations for applying ultra-thin layers of MFT. The applicant notes that technology exists to remove most of the bitumen at a profit prior to processing the MFT for drying. This is shown schematically in FIG. 7 as an optional bitumen recovery station 118 located along the MFT supply line 115.

FIG. 7 shows the lateral MFT distribution and pickup device 120 that moves continuously over the drying zone 104 around the canal 102, drawing MFT out of the canal and distributing the MFT in an ultra-thin, non-continuous MFT layer 30 over the drying zone 104. At any selected time during the process, drying zone 104 is divided into two areas, a deposition area 104a located directly behind the distribution and pickup device 120, and a pickup area 104b located directly in front of the distribution and pickup device 120. Distribution area 104a contains the newly deposited ultra-thin layer of MFT 30 that has just commenced the drying process, while pickup area 104b contains the dried MFT shards 34, ready to be picked up by the MFT distribution and pickup device 120.

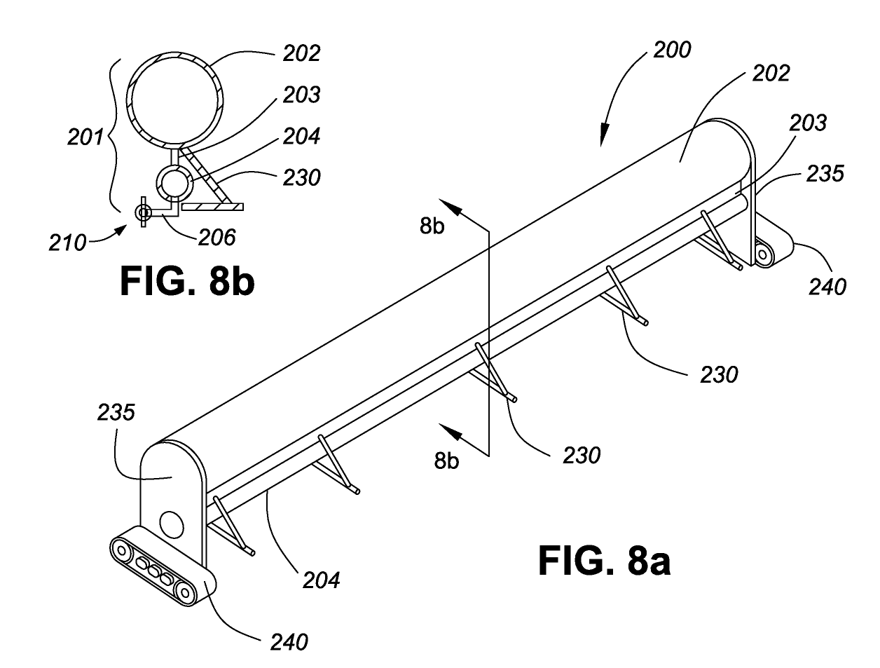

FIGS. 8a and 8b show a pipe lateral and tool support structure 200, which is a central component of the lateral MFT distribution and pickup device 120. FIG. 8b is a cross-section along the lines A-A of FIG. 8a. Pipe lateral and tool support structure 200, includes a truss component 201 that includes a hollow pipe structural support component 202, which supports a lateral MFT distribution pipe 204 on a connecting structural component 203, and an MFT layering tool 210 connected by an MFT input pipe 206 to one side of the lateral MFT distribution pipe 204 for depositing the ultra-thin layer of MFT 30, while pickup tool holders 230 are located on the other side for holding an MFT pickup tool 400 (see FIG. 12). A rubber track connector 235 connects the truss component 201 at each end to individually driven rubber tracks 240.

One purpose of the pipe lateral and tool support structure 200 is to deposit the non-continuous, ultra-thin layer of MFT 30 over the drying zone 104 and to pick up the dried MFT shards 34 as the MFT distribution and pickup device 120 moves continuously over the drying zone 104. Another purpose is to provide support for MFT layering tool 210 and the pickup tool 400, as well as the lateral MFT distribution pipe 204 used to transport the MFT out of the canal 102. Another purpose is to propel the pipe lateral and tool support structure 200 over the surface while performing the MFT distribution and pickup functions.

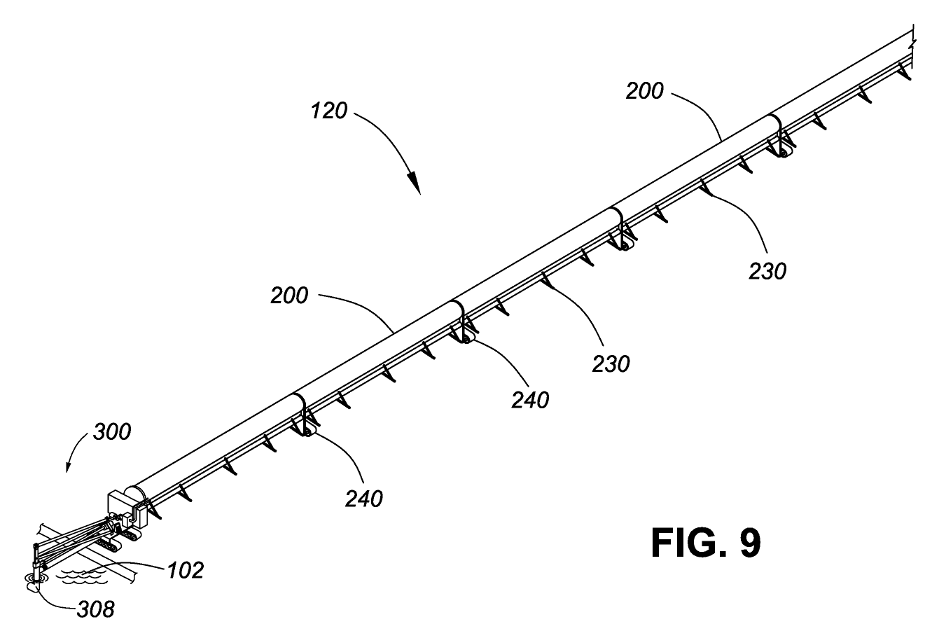

To minimize MFT velocity in the lateral distribution pipe 204 the pipe diameter must be much larger than for pipes used in water irrigation. Typical pipe diameters will be in the range of 12 inches. It is important to maintain the flow rate of MFT in the distribution pipe 204 in the laminar range and avoid turbulence. As MFT is discharged from the lateral distribution pipe 204, subsequent lateral distribution pipes 204 in a chain of multiple pipe lateral and tool support structures 200 (see FIG. 9) could be reduced in size while still maintaining laminar flow of the MFT. An MFT flow velocity of one meter per second is recommended.

The large diameter lateral distribution pipes 204 will become quite heavy when filled with MFT, which significantly increases the wheel pressure of the pipe lateral and tool support structure 200 to the point where the substrate surface could be deformed. The applicant has found it advantageous to use rubber track drives 240 in place of wheel sets due to the more efficient ground pressure distribution of such drive assemblies. The rubber track drives 240 lower the pressure on the substrate and provide the force needed to propel the pipe lateral and tool support structure 200 against the ground resistance forces associated with it and the MFT pickup tool.

As shown in FIG. 9, multiple pipe lateral and tool support structures 200 may be connected in series so as to extend the lateral coverage of the MFT distribution and pickup device 120 to distribute and pickup MFT over a larger processing area. Each pipe lateral and tool support structure 200 includes one individually driven rubber track 240 mounted at each end, with adjacent structures sharing a single rubber track drive. The speed of each rubber track drive 240 is independently controlled so as to collectively control the speed and direction the entire MFT distribution and pickup device 120, while keeping the whole structure in a straight line. The relative drive speed of each rubber track drive 240 is coordinated and independently controlled so as to determine whether the structure moves in a straight line or turns clockwise or counterclockwise.

The light rubber tracks of the rubber track system 240 are vulnerable to failure if they are subject to continuously turning in one direction. In traditional operations, such as on skid steer loaders and light excavators, these rubber track drives are required to turn both clockwise and counterclockwise, and in doing so excessive wear in the same general area is avoided. When used in the disclosed MFT distribution and pickup device 120 the rubber track drives 240 move in a straight line parallel to the supply canal for most of the cycle. However, when turning through the lateral swing areas 107 at the ends of the MFT supply canal 102, the track drives are subject to continuous, localized twisting and torsional wear. One way to reduce this localized wear to a more manageable level is to drain the MFT from the lateral distribution pipe 204 back into the canal 102 before entering the lateral swing area 107. This will reduce the ground pressure on the tracks by 75-80% and allow the tracks to turn with significantly reduced wear. Once the turn is completed and the MFT distribution and pickup device 120 is once again oriented perpendicular to the canal 102, the device is stopped and the MFT is pumped back into the lateral distribution pipe 204. The pickup and layering of MFT then continues in a straight line to the other end of the drying zone 104 where the process is repeated to make the turn through the opposite lateral swing area 107. The MFT distribution and pickup device 120 moves around the MFT supply canal 102 in a continuous cycle, the frequency of which is determined by the drying rate of the ultra-thin layer of MFT 30 and will only be interrupted by adverse weather events. Moisture sensors can be used to measure the moisture content of the dried MFT and control the speed of the MFT distribution and pickup device 120.

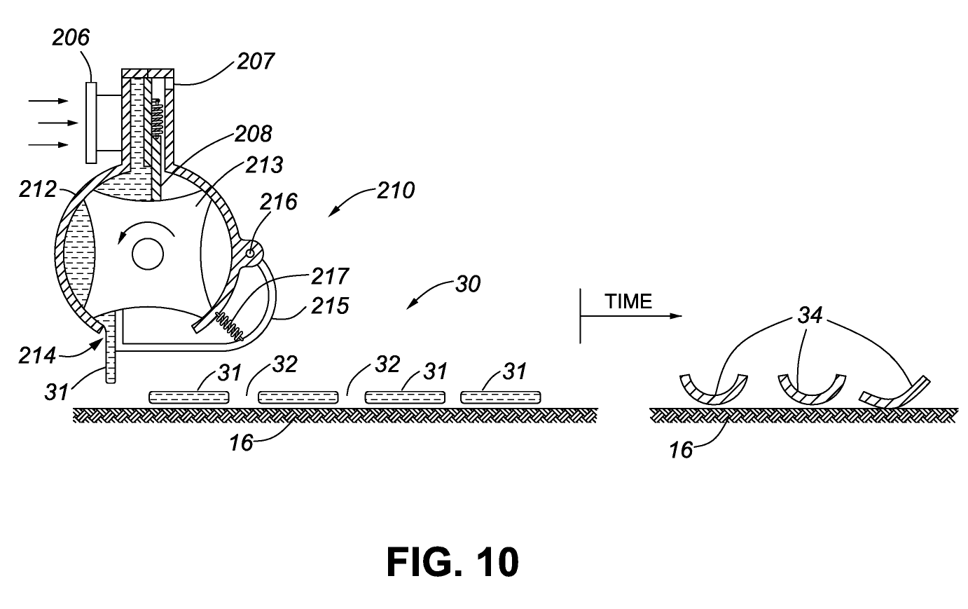

One example of the MFT layering tool 210 is shown in FIG. 10. The layering tool 210 includes a MFT inlet supply pipe 206 to bring MFT from the lateral distribution pipe 204. A generally rectangular MFT layering cam 213 rotates inside a circular MFT layering pipe 212. Each one-quarter revolution of the cam 213 will eject a measured amount of MFT though an MFT ejection port 214 located at the bottom of the layering pipe 212, the width of which is controlled by a spring-loaded scraper arm 215, which also serves to scrape MFT off the cam 213, depositing it onto the surface substrate 16 in a precisely controlled layer. Scraper arm 215 is connected to the layering pipe 212 at a pivot point 216, and a spring 217 keeps the scraper arm 215 pressed in place against the layering cam 213. An air vent 207 is located opposite the ejection port 214 and separated from the MFT flow by a spring-loaded gate 208. Each pipe lateral and tool support structure 200 has its own independent layering tool 210 that extends laterally between the two rubber track drives 240.

The layering tool 210 operates at the trailing edge of the lateral distribution pipe 204, ejecting a patterned, non-continuous, ultra-thin layer of MFT 30 onto the surface of substrate 16 as the MFT distribution and pickup device 120 moves continually over the drying zone 104. The pattern that is formed is made up of strips of MFT 31 deposited on the surface parallel with the layering tool 210 and parallel to the lateral distribution pipe 204. Each MFT strip 31 having the same thickness, and being separated by gaps 32 onto which no MFT is deposited. As described herein above with reference to FIG. 5, this technique of depositing ultra-thin strips of MFT 31 onto a sand substrate 16 improves the drying rate of the ultra-thin layer of MFT 30 and its ability to separate from the substrate and form three-dimensional shards 34 when dried. The thickness of the MFT layer 30 deposited on the surface of substrate 16 should be at or near the minimum thickness achievable for the type of substrate on which it is deposited. The applicant's testing has found that for MFT on a silica substrate the hydraulic neutral depth or thickness should be less than 100 mm and preferably less than 10 mm. Ideally, the thickness should be maintained between 3.7 mm and 4.7 mm, with an average depth or thickness of 4.2 mm when applied on a large scale for drying.

The behaviour of the MFT on the particular substrate chosen for the drying area 104, will determine the particular pattern of distribution, such as the width of the MFT strips 31 and the width of the gaps 32. Due to the precision required to create the patterned, non-continuous, ultra-thin layer of MFT 30, the MFT layering tool 210 is preferably fed by a positive displacement MFT feed system. Gravity flow systems would be less effective due to the viscosity and thixotropic nature of the MFT. Strips of MFT 31 laid parallel to the MFT layering tool 210 and the lateral distribution pipe 204 are particularly advantageous. The curled-up edges of the dried MFT shards 34 present a convenient means for easy pickup off the substrate. Depositing the MFT in a pattern of circular or rectangular ultra-thin layers, separated by gaps of non-deposit areas of substrate, would also be possible and could present certain advantages. Other patterns could also be desirable.

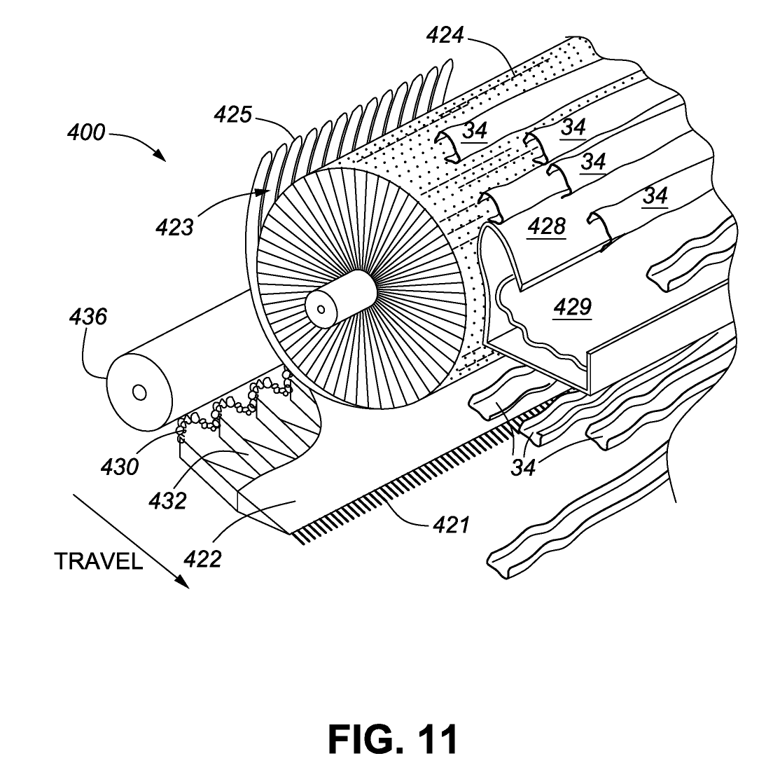

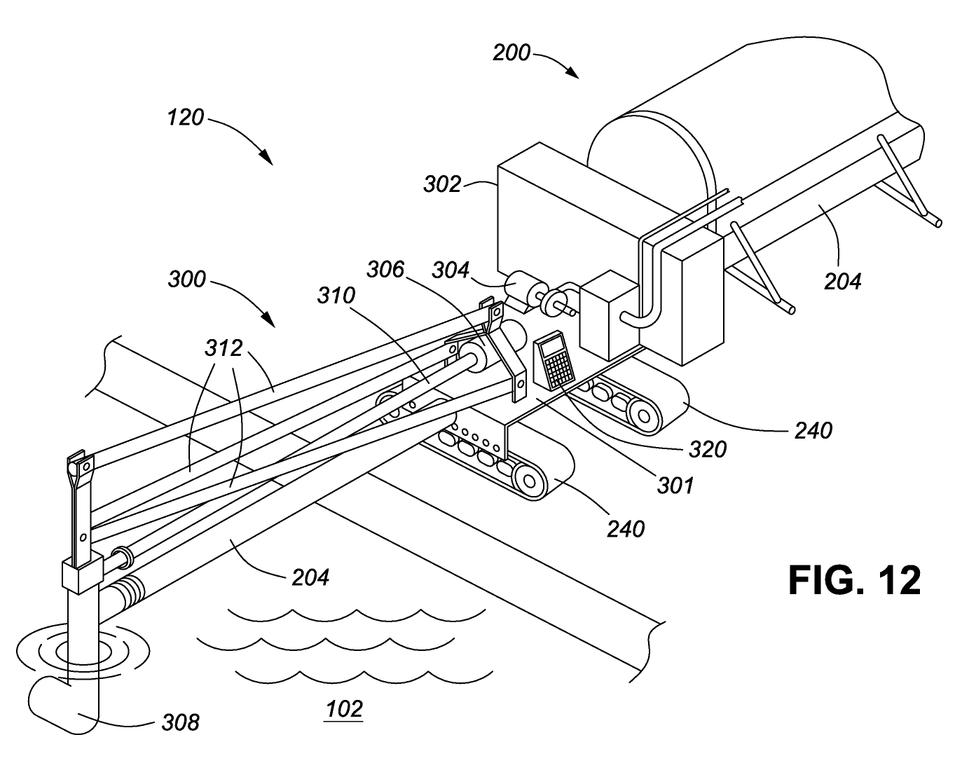

As shown in FIG. 11, the MFT pickup tool 400 extends parallel to the lateral distribution pipe 204 and is connected to the pipe lateral and tool support structures 200 by pickup tool holders 230 (see FIGS. 8 and 9). The pickup tool 400 includes pickup fingers 421, which form a thin leading edge of a floating shoe lifting wedge 422 that feeds the dried shards 34 into a space 423 between a rotating brush cylinder 424 and a finger shroud 425. The pickup fingers 421 slide between the dried MFT shards 34 and the surface of substrate 16 to isolate the shard from the substrate. The rotating brush cylinder 424 pushes the shards 34 into the annular space 423 between the brush 424 and the finger shroud 425 and delivers the shards onto a discharge slide 428, where they are transferred to a cross conveyer 429 running parallel to the lateral distribution pipe 204. The cross conveyor 429 carries the dried shards 34 to the end of the pipe lateral and tool support structure 200 and either deposits them onto the windrow collection area 106 at the edge of the drying area 104 or transfers them to the cross conveyer of the adjacent pipe lateral and tool support structure 200. While each cross conveyor 429 is attached independently to its own pipe lateral and tool support structure 200, the conveyors would overlap at the ends, so that together the conveyors would feed all the collected dried MFT shards to the end of the distribution and pickup device 120 and onto the windrow collection area 106 located at the outer edge of the drying area 104. The cross conveyors 429 could be either continuous wrap or vibratory. Since the silica sand grains on the substrate 16 are of a uniform small size the lifting wedge 422 and pickup fingers 421 can be very light structurally without risk of damage since it will be unlikely to encounter large obstacles such as stones or roots that could cause damage. This makes it much easier to insert the thin lead edge of the pickup fingers 421 under the dried MFT shards 34 without pushing the shards forward and jamming up the pickup system. Since the pickup tool 400 can be constructed of lightweight materials, it will be easy to lift it up a few inches using small hydraulic cylinders when the distribution and pickup device 120 is turned through the lateral swing areas 107 at the ends of the supply canal 102.

The finger shroud 425 is configured with spaces between the individual fingers that make up the shroud. Thus, when the rotating brush 424 runs faster than the shards 34 being picked up, any silica sand particles loosely attached to the dried shards 34 are scrubbed off and fall back to the surface of the drying zone 104. This reduces the rate at which sand particles are removed from the drying zone 104 relative to the area under the track drives 240. This problem is discussed further below.

As also shown in FIG. 11, pickup tool 400 may include drag chains 430 connected to the rear part of the floating shoe lifting wedge 422 by chain holders 432. The drag chains 430 scarify the surface and are followed by a ground support roller 436, which re-compacts the surface and carries a portion of the weight of the pickup tool to ensure that the floating shoe lifting wedge 422 slides lightly along the surface without gouging into the substrate.

As discussed briefly above, approximately three layers of silica sand particles will bond to the thin drying layer of MFT. Since the distribution and pickup device 120 could cycle more than 400 times per season, up to 1200 silica sand particle diameters could be removed from the surface of the drying zone 104. Since silica particles are not removed by this process in the areas under the track drives 240, this can result in digging a trench around the drying zone 104, leaving the tracks drives elevated relative to the layering and pickup tools 210, 400. While the layering and pickup tools are designed to float, and be vertically adjustable, and while the rotating brush 424 will remove some sand particles from the dried shards 34, returning them to the drying zone (see discussion above), a more aggressive approach is contemplated by the applicant. At either the lead or trailing edge of each track drives 240 one or more air nozzles may be installed to blow silica sand particles away from the track drive path, redistributing the particles over the drying zone 104, thereby lowering the track drive path to the same level as the drying zone 104. When the level of the layering and pickup tools drops sufficiently low relative to the track drives 240, air flow starts through the nozzles blowing silica sand particles away from the track drive path, lowering the track drives to the level of the pickup and layering tools, at which point the air flow to the nozzles shuts off. Of course, this problem can be further addressed by periodically re-leveling the drying zone 104 during annual maintenance or planned shut down for rain events.

FIG. 12 shows a control and power supply module 300 of the MFT distribution and pickup device 120, which connects to the supply canal side of the first pipe lateral and tool support structure 200 to control and supply power to the pipe lateral and tool support structures 200 and pump MFT from the supply canal 102 into the lateral distribution pipe 204. The control and power supply module 300 is located on a platform 301 and includes a diesel electric generator 302 to provide power to the rubber track drives 240, the cross conveyors 429 of the pickup tool 400, a hydraulic pump 304, and a propeller drive motor 306 for powering an MFT propeller pump 308. The control and power supply module 300 shares a rubber track drive 240 with the first pipe lateral and tool support structure 200 and includes a second rubber track drive 240 that is the first track drive 240 in the sequence and supports the MFT propeller pump 308 suspended in the MFT supply canal 102. The MFT propeller pump 308 pumps MFT through the lateral distribution pipe 204 to the layering tools 210 and reverses to drain MFT out of the lateral distribution pipe 204 to reduce the load on the rubber track drives 240 prior to turning the MFT distribution and pickup device 120 in the lateral swing areas 107 at the ends of the supply canal 102. The electric motor drive 306 for the MFT pump 308 rests on the same platform 301 as the generator 302 and power is delivered to the MFT propeller pump 308 by a mechanical drive shaft 310. The propeller pump 308 is raised and lowered by three mechanical arms 312 fastened to the generator platform 301 and powered by a hydraulic cylinder. The MFT propeller pump drive and positioning system are similar to the three-point hitch and power-take-off (PTO) systems used on farm tractors since the 1950's.

Also, located on the control and power supply module platform 301, is a central computer control system 320 which controls all operational parameters of the MFT distribution and pickup device 120, including the speed of each track drive 240 to keep the pipe lateral and tool support structures 200 in line, operating as a single unit. It is anticipated that the MFT distribution and pickup device 120 disclosed herein will have a self-diagnostic capability that will automatically shut the system down if it is unable to correct any problem or discrepancy. It is further intended that the device 120 will operate without direct human supervision or control, with diesel supply and engine maintenance being the only scheduled interaction by operating staff.

The previous detailed description is provided to enable any person skilled in the art to make or use the method and apparatus for processing MFT using ultra-thin layer drying. Various modifications to those embodiments will be readily apparent to those skilled in the art, and the generic principles defined herein may be applied to other embodiments without departing from the scope of the method and apparatus for processing MFT using ultra-thin layer drying described herein. Thus, the present method and apparatus for processing MFT using ultra-thin layer drying is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known to those of ordinary skill in the art are intended to be encompassed by the elements of the claims.

1. A method for dewatering mature fine tailings (MFT), the method comprising:
depositing a thin layer of MFT onto a surface of a substrate;
leaving the thin layer of MFT on the surface for a pre-determined amount of time to permit evaporation of water from the MFT into the atmosphere and drainage of the water into the substrate, thereby creating dried MFT having a desired solids content; and
harvesting the dried MFT off the surface,
wherein the thin layer of MFT is less than 100 mm in thickness.

2. The method of claim 1, wherein the thin layer of MFT is less than 10 mm in thickness.

3. The method of claim 1, wherein the thin layer of MFT is between about 3.7 mm and about 4.7 mm in thickness.

4. The method of claim 1, wherein the thin layer of MFT has an average thickness of about 4.2 mm.

5. The method of claim 1, wherein the desired solids content of the dried MFT is between about 66% and about 85% solids.

6. The method of claim 1, wherein the thin layer of MFT is a non-continuous thin layer comprising areas of MFT separated by areas containing no MFT.

7. The method of claim 1, wherein depositing the thin layer of MFT is carried out in a drying area, wherein the drying area comprises two drying zones separated by a distribution canal, and a lateral swing area located at each end of the canal, wherein the canal holds a supply of the MFT.

8. The method of claim 7, wherein the depositing and the harvesting are carried out simultaneously by a single mobile device as the device moves around the canal over the two drying zones in a continuous cycle.

9. The method of claim 8, wherein the mobile device comprises:
a pump for pumping the MFT out of the canal into a lateral MFT distribution pipe;
at least one MFT layering tool connected to the lateral MFT distribution pipe for use in the depositing of the thin layer of MFT onto the surface of the drying zones; and
at least one MFT pickup tool for use in the harvesting of the dried MFT off the surface.

10. A mobile MFT distribution and pickup device for dewatering mature fine tailings (MFT) on a surface of a drying area, the device comprising:
a control and power supply module;
a drive means configured to move the device over the surface of the drying area in at least a forward direction;
at least one pipe lateral and tool support structure connected to the control module, the pipe lateral and tool support structure comprising:
a lateral MFT distribution pipe;
at least one MFT layering tool connected to the lateral MFT distribution pipe configured to deposit a thin layer of MFT onto the surface of the drying area as the device moves over the surface; and
at least one MFT pickup tool configured to harvest dried MFT off the surface as the device moves over the surface; and
a pump configured to pump the MFT into the distribution pipe.

11. The device of claim 10, wherein the thin layer of MFT is less than 100 mm in thickness.

12. The device of claim 10, wherein the thin layer of MFT is less than 10 mm in thickness.

13. The device of claim 10, wherein the thin layer of MFT is between about 3.7 mm and about 4.7 mm in thickness.

14. The device of claim 10, wherein the thin layer of MFT has an average thickness of about 4.2 mm.

15. The device of claim 10, wherein the dried MFT has a solids content of between about 66% and about 85% solids.

16. The device of claim 10, wherein the thin layer of MFT is a non-continuous thin layer comprising areas of MFT separated by areas containing no MFT.

17. The device of claim 10, wherein the drying area comprises two drying zones separated by a distribution canal and a lateral swing area located at each end of the canal, wherein the canal contains a supply of MFT, and wherein the layering tool and the pickup tool are configured to simultaneously deposit the thin layer of MFT and harvest the dried MFT in a continuous operation as the device moves around the canal over the two drying zones and the pump pumps the MFT out of the canal into the lateral MFT distribution pipe.

18. The device of claim 10, wherein the pickup tool comprises a lifting wedge positioned to separate the dried MFT from the surface and feed the dried MFT onto a rotating brush.

19. The device of claim 10, wherein the pickup tool comprises a cross conveyor configured to transport the dried MFT to a collection area.

20. The device of claim 10, wherein the pickup tool comprises drag chains and a ground support roller configured to condition the surface prior to receiving the thin layer of MFT.
